(19) United States
(12) Patent Application Publication
(10) Pub. No.: US 2006/0278451 A1
(43) Pub. Date: Dec. 14, 2006

(54) Vehicular radiator unit

(75) Inventors: Shinji Takahashi, Saitama (JP); Shinji Kawatani, Saitama (JP)

Correspondence Address: BIRCH STEWART KOLASCH & BIRCH, PO BOX 747, FALLS CHURCH, VA, 22040-0747, US

(73) Assignee: HONDA MOTOR CO., LTD.

(21) Appl. No.: 11/448,077

(22) Filed: Jun. 7, 2006

(30) Foreign Application Priority Data
Jun. 10, 2005 (JP) 2005-170675

(51) Int. Cl. B60K 11/00

(52) U.S. Cl. 180/68.1

(57) ABSTRACT

A vehicular radiator unit has an improved support stay for a cooling fan, making it possible to reduce the amount of time necessary to mount the cooling fan to a heat radiating part. The vehicular radiator unit includes a radiator supported by a body frame. A cooling fan enhances the heat radiating performance of the radiator. A support stay supports the cooling fan and is attached to the radiator. The support stay includes plural arms. The lower arm holds the radiator by sandwiching a peripheral portion thereof.

### CROSS-REFERENCE TO RELATED APPLICATIONS

This nonprovisional application claims priority under 35 U.S.C. § 119(a) on patent application Ser. No. 2005-170675, filed in Japan on Jun. 10, 2005, the entirety of which is incorporated herein by reference.

### BACKGROUND OF THE INVENTION

1. Field of the Invention

The present invention relates to a radiator unit for a vehicle such as an ATV (All Terrain Vehicle).

2. Description of Background Art

In a conventional example of a radiator unit for a vehicle such as an ATV, a cooling fan is attached, via a support stay, to a flange (a fastening part) provided on a periphery of a radiator (a heat radiating part) (see JP-A No. 313386/2000, for example).

The technology mentioned above uses a configuration in which three fastened parts provided in the support stay are respectively fastened to the fastening part provided on the periphery of the heat radiating part. When mounting the cooling fan in such a configuration, it is necessary to use adequate care to prevent the fastened parts and tools from touching the heat radiating part (radiator core). Hence, there has been cases in which the amount of time to mount the cooling-fan is increased.

### SUMMARY OF THE INVENTION

The present invention provides a vehicular radiator unit that has an improved support stay for a cooling fan, making it possible to reduce the amount of time required to mount the cooling fan to a heat radiating part.

As a means for solving the problem, a first aspect of the present invention provides a vehicular radiator unit that includes a heat radiating part (for example, the radiator 60 of the embodiment) supported by a body frame (for example, the body frame 4 of the embodiment). A cooling fan (for example, the cooling fan 61 of the embodiment) enhances the heat radiation of the heat radiating part. A support stay (for example, the support stay 62 of the embodiment) supports the cooling fan and is attached to the heat radiating part. The support stay includes plural arms (for example, the arms 84, 85, and 86 of the embodiment). At least one of the arms is a holding arm that holds the heat radiating part by sandwiching a periphery thereof.

According to the above configuration, when mounting the cooling fan to the heat radiating part, the arms other than the holding arm of the support stay can be fastened to the heat radiating part in a state in which the holding arm that holds the heat radiating part by sandwiching a periphery thereof has been attached thereto. In this way, in the process of mounting the cooling fan, the worker is required to support the support stay less frequently, and the support stay and tools can be effectively prevented from touching the heat radiating part. Thus, the cooling fan can be mounted to the heat radiating part with ease and the amount of time required to mount the cooling fan can be reduced.

According to a second aspect of the present invention, the periphery of the heat radiating part is provided with a fastening part (for example, the upper flange 78 of the embodiment) to which the arms other than the holding arm are fastened. The arms other than the holding arm are provided with plural fastened parts (for example, the fastening hole formed parts 106 of the embodiment) arranged in a plane parallel to a heat radiating surface of the heat radiating part.

According to the above configuration, the fastened parts provided in the arms can be selectively used according to the radiation area of the heat radiating part. The support stay can therefore be used for different heat radiating parts having different radiation areas.

According to a third aspect of the present invention, the vehicular radiator unit has a shroud (for example, the shroud 63 of the embodiment) which covers the periphery provided with the fastening part of the heat radiating part. The shroud is provided with a through part (for example, the upper through hole 108 of the embodiment) through which the fastening part and the fastened parts can project.

According to the above configuration, even in cases where the fastening part projects beyond the periphery of the heat radiating part, the fastening part and the fastened parts can project through the shroud. Therefore, the support stay can be used for heat radiating parts having different radiation areas, and the shroud can be used for such different heat radiating parts.

According to the fourth aspect of the present invention, the body frame supports the heat radiating part via the support stay.

According to the above configuration, the support stay serves also as a stay with which the body frame supports the heat radiating part. Therefore, the number of parts required to support the heat radiating part can be reduced.

According to the first aspect of the present invention, the amount of time required to mount a cooling fan to a radiator can be reduced by making the fastening of a support stay easy.

According to the second aspect of the present invention, a support stay can be used for heat radiating parts having different heat radiation areas.

According to third aspect of the present invention, a shroud can be used for heat radiating parts having different heat radiation areas.

According to fourth aspect of the present invention, the number of parts required to support a heat radiating part can be reduced.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side view of a saddle-ride type four-wheeled vehicle according to an embodiment of the present invention;

FIG. 2 is a top view of the saddle-ride type four-wheeled vehicle;

FIG. 3 is a side view of a body frame of the saddle-ride type four-wheeled vehicle;

FIG. 4 is a side view of a peripheral portion of a radiator unit of the saddle-ride type four-wheeled vehicle;

FIG. 5 is a top view of the peripheral portion of the radiator unit;

FIG. 6 is a view on arrow A in FIG. 4; and

FIG. 7 is an exploded perspective view of the radiator unit.

### DETAILED DESCRIPTION OF THE PREFERRED EMBODIMENTS

Preferred embodiments of the present invention will now be described with reference to the accompanying drawings, wherein the same or similar elements will be identified with the same reference numerals. Unless otherwise stated, the directions front, rear, left, and right as mentioned in the following description are as seen from the vehicle in the direction of travel. The arrows FR, LH, and UP used in the drawings denote the forward, leftward, and upward directions, respectively, also as seen from the vehicle.

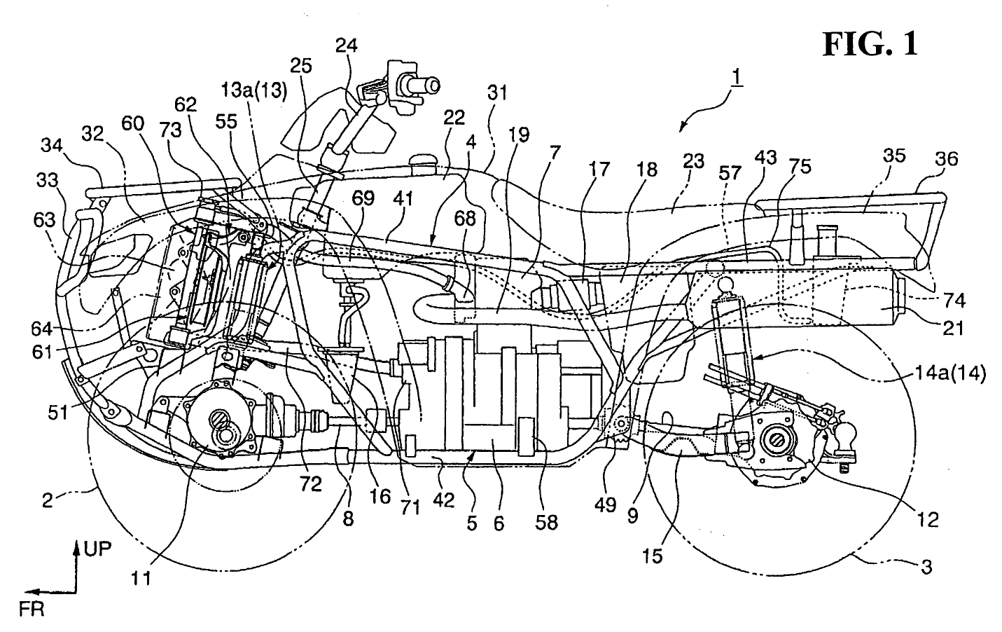

A saddle-ride type four-wheeled vehicle 1 shown in FIG. 1 is a so-called ATV (All Terrain Vehicle) having a pair of left and right front wheels and a pair of left and right rear wheels provided in front and rear portions, respectively, of a small and light vehicle body. With the wheels being made of low-pressure balloon tires having a relatively large diameter, a large ground clearance is secured for the vehicle body, and the ATV features high running through performance.

An engine 5 is mounted, as a prime mover for the saddle-ride type four-wheeled vehicle 1, in an approximately central portion of a body frame 4. The engine 5 is a water-cooled single-cylinder engine. It is a so-called longitudinal layout engine with the rotational axis of its crankshaft extending in the front-rear direction of the vehicle. A crankcase 6 making up a lower portion of the engine 5 serves also as a transmission case. Front and rear propeller shafts 8 and 9 extend forward and rearward from front and rear portions of the crankcase 6, respectively.

The front and rear propeller shafts 8 and 9 are, in front and rear lower portions of the body frame 4 and are transmissibly connected to the front wheels 2 and the rear wheels 3 via front and rear speed reducing mechanisms 11 and 12, respectively. The front wheels 2 are suspended, in a front portion of the body frame 4, by an independent front suspension 13 (double wishbone type). The rear wheels 3 are suspended, in a rear portion of the body frame 4, by a rigid axle rear suspension 14 and swing arms 15.

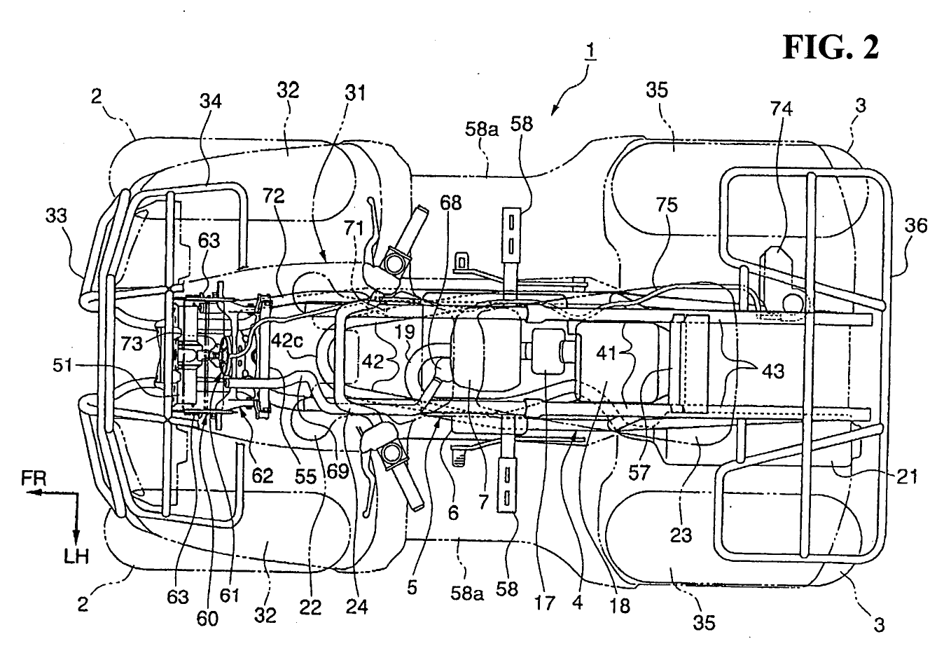

Referring to FIG. 2, a throttle body 17 is connected to a rear portion of a cylinder section 7 that is vertically installed on the crankcase 6 in the engine 5. An air cleaner case 18 is connected to a rear portion of the throttle body 17. The base end of an exhaust pipe 19 is connected to a front portion of the cylinder section 7. The exhaust pipe 19, after extending forward from the cylinder section 7, turns back to extend rearward on the left side of the cylinder section 7 allowing its leading end to be connected to a silencer 21 in a rear portion of the vehicle body. In FIG. 1, reference numeral 16 denotes a fuel pump which pressure-feeds fuel to an injector of the throttle body 17.

A steering shaft 25, a fuel tank 22, and a saddle-type seat 23 are arranged, in this order, from front to rear in an upper central portion relative to the vehicle width direction of the saddle-ride type four-wheeled vehicle 1. A bar-type handle 24 is slanted forward and upward of the fuel tank 22 and is attached to an upper end portion of the steering shaft 25. A lower end portion of the steering shaft 25 is connected to a front wheel steering mechanism (not shown). A radiator (heat radiating part) 60 included in a radiator unit for the engine 5 is installed in a position downward and forward of the steering shaft 25.

A body cover 31 is made of resin and appropriately covers a front portion of the vehicle body. Front fenders 32 are also made of resin and cover a top portion through a rear portion of one of the front wheels 2. A front protector 33 and a front carrier 34 that are mainly made of steel are attached to a front portion of the body frame 4. Rear fenders 35 are made of resin and cover a top portion through a front portion of one of the rear wheels 3. Arear carrier 36 is mainly made of steel and is attached to a rear portion of the body frame 4.

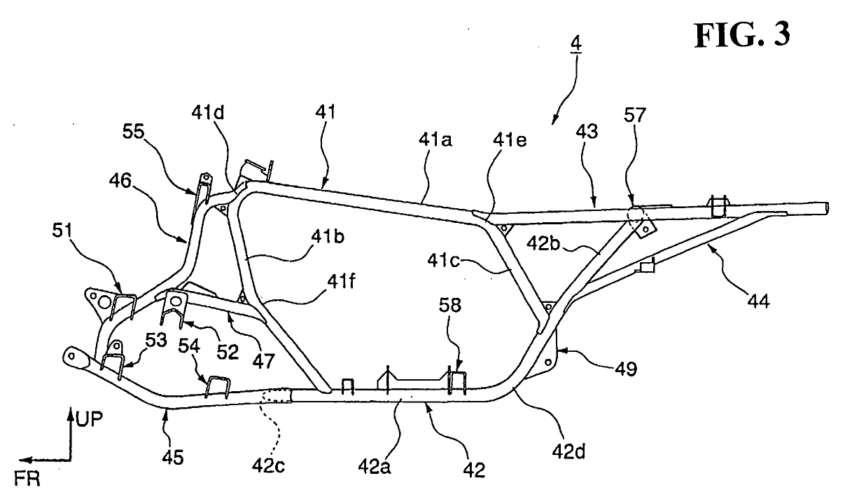

Referring to FIG. 3, the body frame 4 is made of plural steel parts connected into a unified structure, for example, by welding. In more concrete terms, it has a long box-like structure disposed longitudinally in the front-rear direction in a central portion relative to the width direction of the body frame 4. The box-like structure includes a pair of left and right closed loop structures linked to each other by plural cross members. The pair of left and right closed loop structures are mainly composed of a pair of left and right upper pipes 41 and a pair of left and right lower pipes 42. In the following, unless otherwise stated, the left portion of the body frame 4 will be described. Since the left and right portions of the body frame 4 are symmetrical, description of the right portion of the body frame 4 will be omitted.

The upper pipe 41 includes an upper inclined portion 41a which, being in an upper outside portion of the body frame 4, is slightly inclined downwardly and rearwardly. A front inclined portion 41b extends from a front end portion of the upper inclined portion 41a and slants downwardly and rearwardly to form an acute angle with the upper inclined portion 41a. A rear inclined portion 41c extends from a rear end portion of the upper inclined portion 41a and slants downwardly and rearwardly to form a blunt angle with the upper inclined portion 41a. The portions 41a, 41b, and 41c are made of a single steel pipe bent to form the three portions. There is a front bend 41d formed between the upper inclined portion 41a and the front inclined portion 41b of the upper pipe 41. There is a rear bend 41e formed between the upper inclined portion 41a and the rear inclined portion 41c. Also, a forwardly projecting midpoint bend 41f is formed at an approximately middle portion of the front inclined portion 41b.

The lower pipe 42 includes a lower horizontal portion 42a that extends approximately horizontally in a lower outside portion of the body frame 4 and a rear inclined portion 42b that slants upward and rearward from a rear end portion of the lower horizontal portion 42a forming a blunt angle with the lower horizontal portion 42a. The portions 42a and 42b are made of a single steel pipe bent to form the two portions. The left and right lower pipes 42 make up a unified structure with their front end portions (front end portions of their lower horizontal portions 42a) being connected with each other by a circular arc portion 42c projecting forward as seen from above (see FIG. 2). There is a lower bend 42d between the lower horizontal portion 42a and the rear inclined portion 42b of the lower pipe 42.

A lower end portion of the front inclined portion 41b of the upper pipe 41 is joined to the vicinity of a front end portion of the lower horizontal portion 42a of the lower pipe 42. A lower end portion of the rear inclined portion 41c of the upper pipe 41 is joined to an approximately middle portion in the longitudinal direction of the rear inclined portion 42b of the lower pipe 42. A triangular pivot bracket 49 is integrally provided behind a lower portion of the rear inclined portion 41c of the upper pipe 41. The pivot bracket 49 is for supporting a front end portion of the swing arm 15 in the rear suspension 14.

A front end portion of a rear upper pipe 43 that extends approximately horizontally acts as a seat rail and is joined to the rear bend 41e of the upper pipe 41. An upper end portion of the rear inclined portion 42b of the lower pipe 42 is joined to an approximately middle portion in the longitudinal direction of the rear upper pipe 43. A rear subpipe 44 extends from an approximately middle portion in the longitudinal direction of the rear inclined portion 42b of the lower pipe 42 and slants upwardly and rearwardly to a rear end portion of the rear upper pipe 43. A rear cross pipe 57 is a cross member connecting approximately middle portions in the longitudinal direction of the left and right rear upper pipes 43.

A rear end portion of an approximately horizontal front lower pipe 45 is joined to the vicinity of a front end portion of the lower horizontal portion 42a of the lower pipe 42. The front lower pipe 45 is bent to slant upward and forward at a position in the vicinity of an axle of the front wheels 2, as viewed from a side of the vehicle body. A lower end portion of the front protector 33 is connected to a front end portion of the front lower pipe 45. The lower horizontal portion 42a is provided with a step bar 58. The step bar 58 and a step board 58a make up a boarding step.

An upper end portion of a front cushion pipe 46 spans from the front bend 41d to the vicinity of a front end portion of the front lower pipe 45 and is joined to the front bend 41d of the upper pipe 41. The front cushion pipe 46 extends forward from the upper bend 41 d of the upper pipe 41 and is bent, at a position not much away from the upper bend 41d, to slant downward and forward. It then further extends in a gently curved crank-like shape, causing a lower portion thereof to be forward of an upper portion thereof. A lower end portion of the front cushion pipe 46 is joined to the vicinity of a front end portion of the front lower pipe 45. An approximately middle portion in the up-down direction of the front cushion pipe 46 and the midpoint bend 41f of the upper pipe 41 are spanned by a front subpipe 47 that slants upward and forward.

The left and right front cushion pipes 46 are spanned by a mid-level front cross beam 51 and an upper cross beam 55. The cross beams 51 and 55 both extend laterally. Similarly, the left and right front lower pipes 45 are spanned by a lower front cross beam 53 and a lower rear cross beam 54. The left and right front subpipes 47 are spanned by a mid-level rear cross beam 52.

Base ends of left and right upper arms (not shown) of the front suspension 13 are oscillatably and pivotally supported on both sides of the mid-level front and rear cross beams 51 and 52. Base ends of left and right lower arms (not shown) are oscillatably and pivotally supported on both sides of the lower front and rear cross beams 53 and 54. Hub portions of the left and right front wheels 2 are rotatably supported, via knuckles, by front end portions of the left and right upper and lower arms. In FIG. 1, the reference mark 13a denotes front cushion units interposed between the left and right upper arms and both sides of the upper cross beam 55.

The rear suspension 14 is mainly composed of the swing arms 15 and rear cushion units 14a. A front end portion of the swing arm 15 is vertically swingably supported by the pivot bracket 49. A rear end portion of the swing arm 15 pivotally supports a rear axle shaft that spans hub portions of the left and right rear wheels 3. The rear cushion unit 14a is interposed between the vicinity of a rear end of the swing arm 15 and the rear cross pipe 57 of the body frame 4.

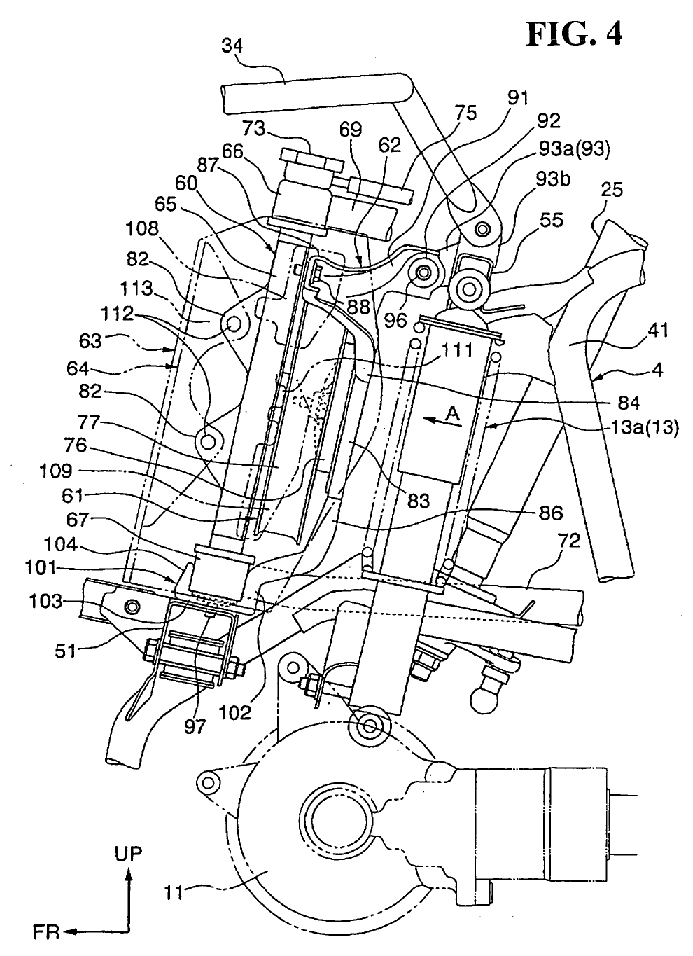

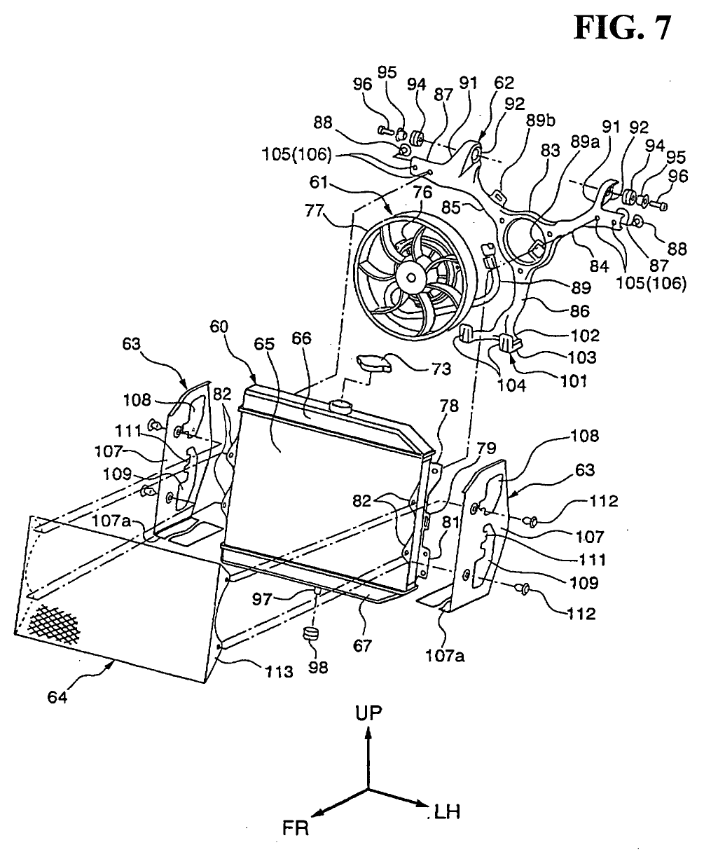

As shown in FIGS. 4 and 7, a radiator unit for the engine 5 of the saddle-ride type four-wheeled vehicle 1 is mainly composed of the radiator 60 disposed forward of the axle of the front wheels 2. An electric cooling fan 61 is disposed directly behind the radiator 60. A support stay 62 supports the cooling fan 61. A pair of shrouds (air intake guides) 63 cover both sides of the radiator 60. A grille 64 is disposed directly in front of the radiator 60 to cover the radiator 60.

The radiator 60 includes a radiator core 65 that is shaped like an approximately square plate, as viewed from the front, and id disposed perpendicularly to an axis line which is slightly inclined upwardly and forwardly. Upper and lower tanks 66 and 67 are disposed along the top side and underside of the radiator core 65, respectively, and are integrally joined with the radiator core 65. Namely, the radiator 60 is of a down-flow type (vertical flow type). It is disposed in a position slightly inclined rearward, so that, as viewed from a side, an upper portion of the radiator 60 is rearward of a lower portion of the same.

The cooling fan 61 is disposed behind and along an approximately central portion of the radiator core 65. The cooling fan 61 is fixed to the radiator 60 via the support stay 62. Each of the shrouds 63 is shaped like a plate and is disposed in a plane approximately perpendicular to the vehicle width direction on each side of the radiator core 65. Each of the shrouds 63 is fixed to each side of the radiator core 65. Right in front of the radiator core 65, a grille 64, for example, a meshed one is disposed in a plane inclined to be along with the radiator core 65. Two side portions of the grille 64 are fixed to the corresponding side portions of the radiator core 65 together with the left and right shrouds 63.

Now referring also to FIG. 1, an inlet hose 69 extending from a thermostat 68 disposed in front of the cylinder section 7 is connected to the upper tank 66 above the radiator 60. An outlet hose 72 extends from a water pump 71 disposed in front of the crankcase 6 and is connected to the lower tank 67.

As the engine 5 is operated and the water pump 71 is driven, cooling water circulates through the water pump 71, a cooling water passage in the engine 5, the thermostat 68, the inlet hose 69, the radiator 60 and the outlet hose 72 in the mentioned order. Heat of the engine 5 therefore radiates from the radiator core 65 using the cooling water as a medium. When the engine 5 is operated at low temperature, the thermostat 68 switches the cooling water circulation path to cause the radiator 60 to be bypassed and thereby promote warming up of the engine 5. When the engine 5 is operated at high temperature, the cooling fan 61 is driven to enhance the heat radiation performance of the radiator 60.

Whereas a radiator cap 73 is attached to a water supply port of the upper tank 66, a breather hose 75 extending from a reservoir tank 74 disposed in a rear portion of the vehicle body is connected to the water supply port. The radiator cap 73 has a built-in pressurization valve and a built-in negative pressure valve, so that it can adjust the flow rate of cooling water circulating through the engine 5 and the radiator 60 so as to keep the cooling water pressure in a prescribed range.

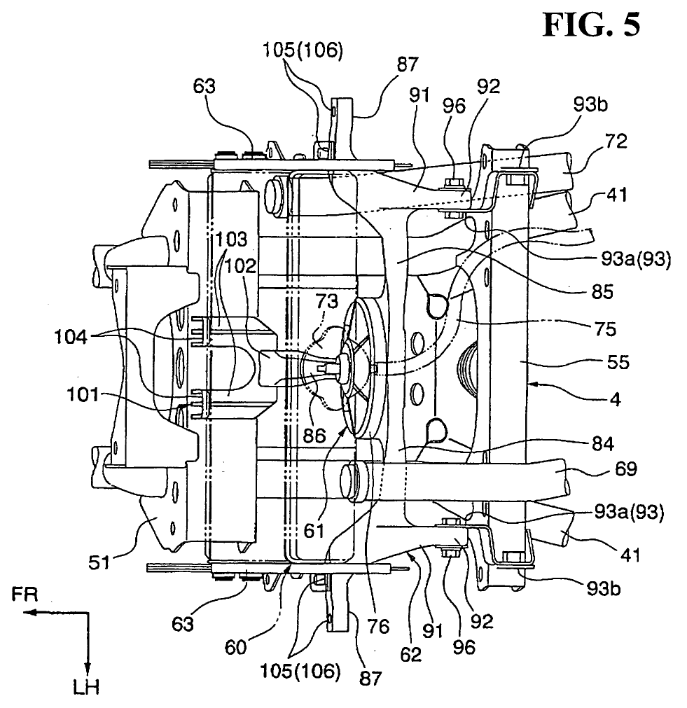

As shown in FIGS. 4 and 5, an upper portion of the radiator 60 (an upper portion of the radiator core 65) is supported by the upper cross beam 55 of the body frame 4 via an upper portion of the support stay 62. A lower portion (the lower tank 67) of the radiator 60 is supported by the mid-level front cross beam 51 of the body frame 4.

The cooling fan 61 is disposed behind and along an approximately central portion of the radiator core 65. It is composed of a flat fan motor 76 having a rotational axis which is approximately perpendicular to the radiator core 65 and which is inclined upwardly and forwardly. A fan body 77 is fixed to a forwardly projecting rotary shaft of the fan motor 76. The fan motor 76 is fixed to an approximately central portion of the support stay 62. It is supported by the radiator 60 via arms 84, 85 and 86 of the support stay 62.

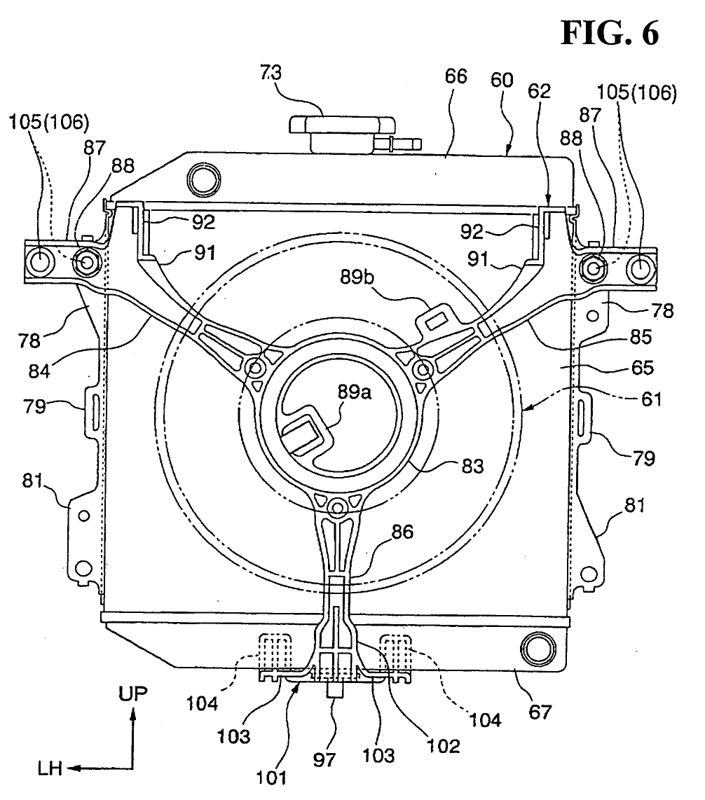

Now referring also to FIGS. 6 and 7, the radiator core 65 has a plate-like outer frame on each side. The outer frame is approximately perpendicular to the vehicle width direction and is provided with an upper flange (fastening part) 78, a middle flange 79, and a lower flange 81 all of which extend from a rear edge of the outer frame outwardly in the vehicle width direction and in a plane approximately parallel with the (front and rear) radiating surfaces of the radiator core 65. The outer frame is also provided with two support flanges 82 each of which projects, from a front edge in a middle portion of the outer frame, forwardly in a triangular shape, as viewed from a side, and in a plane approximately perpendicular to the vehicle width direction.

The support stay 62 is composed of an annular portion 83, which is shaped annularly as viewed from the front and to which the fan motor 76 of the cooling fan 61 is fixed. A left arm 84 slants upward and leftward. A right arm 85 slants upward and rightward. A lower arm (holding arm) 86 extends downwardly. The three arms extend approximately radially from a periphery of the annular portion 83 as viewed from the front. All of the parts have been formed into one structure, for example, by resin molding. The annular portion 83, and the arms 84, 85 and 86 each have a hollow cross-section with an opening generally facing rearward.

End portions of the left and right arms 84 and 85 included in the support stay 62 are each provided with a flange-abutting part 87, which abuts the upper flange 78 on a side of the radiator 60 from behind. The upper flange 78 is fitted, for example, with a clip nut. Then, screwing a bolt 88 inserted through the upper flange 78 and the flange-abutting part 87 from behind into the clip nut and clamping the clip nut on each side of the radiator 60 clamps the upper sides of the radiator core 65 and the end portions of the left and right arms 84 and 85 together. In FIG. 6, the reference mark 89a denotes a harness clip which holds a power supply harness 89 (see FIG. 7) extending from the cooling fan 61, and the reference mark 89b denotes a fixture portion for fixing a connector at an end of the power supply harness 89.

A rearward extension part 91 is provided in an inner portion, as viewed along the vehicle width direction, of the flange-abutting part 87. The rearward extension part 91 extends rearward from the inner portion. A supported part 92 is approximately perpendicular to the vehicle width direction and is provided in a rear end portion of the rearward extension part 91. The upper cross beam 55 of the body frame 4 is positioned immediately behind the supported part 92. Each side of the upper cross beam 55 is provided with a support bracket 93 having a support part 93a which abuts the supported part 92 from inside as viewed in the vehicle width direction.

The supported part 92 is fitted with a rubber mount 94. A collar 95 and a bolt 96 are both inserted through the rubber mount 94 in the vehicle width direction and are fastened to the support part 93a using a nut hole provided in the support part 93a, causing the upper portion on each side of the support stay 62 (radiator 60) to be elastically supported by the body frame 4 via the bolt 96, the collar 95 and the rubber mount 94. An upper portion of the support bracket 93 is integrally provided with a carrier support part 93b that supports a rear end portion of the front carrier 34.

A lock pin 97 projects downward along the inclination of the radiator 60 and is provided in an approximately middle portion, relative to the vehicle width direction, of the bottom wall of the lower tank 67. The lock pin 97 engages with the mid-level front cross beam 51, positioned right below the lower tank 67, of the body frame 4 via a rubber mount 98, causing a lower portion of the radiator 60 to be elastically supported by the body frame 4.

An end portion of the lower arm 86 of the support stay 62 is provided with a lock part 101 that engages with a central portion relative to the vehicle width direction of the lower tank 67 from below.

The lock part 101 is shaped like a hook and includes a rear fitting part 102 fitting the lower tank 67 along its rear wall. A lower fitting part 103 extends from a lower end of the rear fitting part 102 along the bottom wall of the lower tank 67. A front fitting part 104 rises from a front end of the lower fitting part 103 along the front wall of the lower tank 67. The lock part 101 having these parts holds the lower tank 67 by sandwiching it therebetween. The lock pin 97 projects downward from the bottom wall of the lower tank 67 through a gap formed in a middle portion relative to the vehicle width direction of the lower fitting part 103 of the lock part 101.

Each of the flange-abutting parts 87 of the support stay 62 extends outwardly in the vehicle width direction. It has, for example, plural (two) fastening holes 105 arranged in the vehicle width direction and in a plane parallel with the radiating surfaces of the radiator 60. In other words, the flange-abutting parts 87 of the support stay 62 each include plural (e.g., two) fastening hole formed parts (fastened parts) 106 arranged in a plane parallel with the radiating surfaces of the radiator 60. In the present embodiment, the flange-abutting parts 87 are fastened to the upper flanges 78 using the inner ones, relative to the vehicle width direction, of the fastening hole formed parts 106.

Each of the shrouds 63 includes a shroud body 107 disposed to be approximately perpendicular to the vehicle width direction and a lower wall part 107a extending inward in the vehicle width direction and along the bottom wall of the lower tank 67 (see FIG. 7).

The shroud body 107 has a top-to-bottom width generally ranging from an upper edge of the radiator core 65 to a lower edge of the lower tank 67. It has a front-to-rear width adequately larger than the corresponding width of the radiator 60. In an upper portion of the shroud body 107, an upper through hole 108 is provided, through which the upper flange 78 and the flange-abutting part 87 can project outwardly in the vehicle width direction. In a lower portion of the shroud body 107, a lower through hole 109 corresponding to the middle flange 79 and the lower flange 81 is provided.

The lower wall part 107a has a front-to-rear width equivalent to that of the shroud body 107 and extends from the lower edge of the shroud body 107 to an approximate center in the width direction of the vehicle. Thus, with the lower wall part 107a extending from the lower edge of the shroud body 107 on each side, the two lower wall parts 107a extending from both sides function as a bottom cover for the radiator 60 to prevent the bottom of the radiator 60 from being directly subjected to muddy water or flying stones.

The shapes of the through holes 108 and 109 may be determined according to the shape of the radiator 60 to which the shroud 63 is attached. In the present embodiment, for example, the upper through hole 108 has a relatively large vertical dimension corresponding to the top-to-bottom width of the upper flange 78 and its front-to-rear width is larger in an upper portion corresponding to the flange-abutting part 87. The upper through hole 108 is notched in a lower front portion thereof. This is to secure opening through which a tool can be inserted when installing a cooling water reservoir tank designed for installation on the left or right side of the radiator 60 depending on the vehicle model. Also in the present embodiment, the lower through hole 109 is vertically long so as to accept both the middle flange 79 and the lower flange 81. The front-to-rear width of the lower through hole 109 is larger in an upper portion thereof.

The lower through hole 109 has, in an upper front portion thereof, a claw-like part 111 formed by correspondingly shaping the lower through hole 109 when making the hole. The claw-like part 111 can engage in a slit provided in the middle flange 79. In a state in which the claw-like part 111 is engaged with the middle flange 79, a front portion of the shroud body 107 is clamped to the two support flanges 82 using two clips 112. A rearwardly extending grille flange 113 is provided on each side of the grille 64. End portions of the grille flange 113 are also clamped, together with the shroud 63, to the support flanges 82 with the clips 112.

As described above, the saddle-ride type four-wheeled vehicle 1 of the above embodiment includes the radiator 60 supported by the body frame 4. The cooling fan 61 enhances the heat radiation performance of the radiator 60. The support stay 62 supports the cooling fan 61 and is attached to the radiator 60. The support stay 62 has the plural arms 84, 85 and 86. The lower arm 86 holds the radiator 60 by sandwiching a lower peripheral portion thereof.

According to the above configuration, when mounting the cooling fan 61 to the radiator 60, the arms 84 and 85 of the support stay 62 can be fastened to the radiator 60 in a state in which the lower arm 86 has been set to hold the radiator 60 by sandwiching the lower peripheral portion thereof. In this way, in the process of mounting the cooling fan 61, the worker is required to support the support stay 62 less frequently, and the support stay 62 and tools can be effectively prevented from touching the radiator core 65. Thus, the cooling fan 61 can be mounted to the radiator 60 with ease and the amount of time required for mounting can be reduced.

In the above radiator unit, the upper flanges 78 are provided in left and right peripheral portions of the radiator 60. The left and right arms 84 and 85 are fastened to the upper flanges 78. The left and right arms 84 and 85 each have plural fastening hole formed parts 106 arranged in a plane parallel with the radiating surfaces of the radiator 60. The fastening hole formed parts 106 can therefore be used selectively according to the radiation area of the radiator 60. Namely, when the lateral width of the radiator core 65 is increased to enlarge the radiation area, the support stay 62 can be fastened to the radiator 60 using the outer one, relative to the vehicle width direction, of the fastening hole formed parts 106 on each side. Thus, the support stay 62 can be used for radiators having different radiation areas.

Furthermore, the above radiator unit is provided with the shrouds 63 that cover left and right peripheral portions where the left and right upper flanges 78 are respectively provided of the radiator 60. Each of the shrouds 63 has an upper through hole 108 through which the upper flange 78 and the fastening hole formed parts 106 can project. Therefore, even when the fastening hole formed parts 106 on both sides of the radiator 60 project beyond the left and right peripheral sides of the radiator 60, the upper flange 78 and the fastening hole formed parts 106 on each side can project through the shroud 63. Thus, where the support stay 62 can be used for radiators having different radiation areas as described above, the shrouds 63 can also be used for such different radiators.

In addition, in the above radiator unit, the body frame 4 supports the radiator 60 via the support stay 62. That is, the support stay 62 serves also as a stay with which the body frame 4 supports the radiator 60. This reduces the number of parts required to support the radiator.

The present invention is not limited to the above embodiment. The upper flanges 78 provided for the radiator 60 and the fastening hole formed parts 106 of the support stay 62 need not be in a plane parallel with the radiating surfaces of the radiator 60. They may be, for example, in a plane perpendicular to or inclined from the radiating surfaces. Also, the parts, that are to be fastened to peripheral portions of the radiator 60, of the support stay 62 may have notches for fastening instead of fastening holes. Furthermore, either one of the left and right arms 84 and 85 may be a holding arm which engages with a peripheral part of the radiator 60 regardless of whether the radiator 60 is of a down-flow type or a cross-flow type (lateral flow type).

The configuration of the above embodiment is an example of the present invention. It is of course possible to apply the configuration to an oil cooler.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A vehicular radiator unit comprising:
a heat radiating part, said heat radiating part being supportable by a body frame;
a cooling fan, said cooling fan enhancing the heat radiation performance of the heat radiating part;
a support stay, said support stay supporting the cooling fan and being attached to the heat radiating part,
wherein the support stay includes plural arms and at least one of the arms is a holding arm that holds the heat radiating part by sandwiching a periphery thereof.

2. The vehicular radiator unit according to claim 1, wherein the periphery of the heat radiating part is provided with a fastening part to which the arms other than the holding arm are fastened, and the arms other than the holding arm are provided with plural fastened parts that are arranged in a plane parallel with a heat radiating surface of the heat radiating part.

3. The vehicular radiator unit according to claim 2, further comprising a shroud that covers a portion of the periphery of the heat radiating part that is provided with the fastening part, and the shroud is provided with a through part through which the fastening part and the fastened parts can project.

4. The vehicular radiator unit according to claim 1, wherein the body frame supports the heat radiating part via the support stay.

5. The vehicular radiator unit according to claim 2, wherein the body frame supports the heat radiating part via the support stay.

6. The vehicular radiator unit according to claim 3, wherein the body frame supports the heat radiating part via the support stay.

7. The vehicular radiator unit according to claim 1, wherein said holding arm includes a rear fitting part, a lower fitting part and a front fitting part, said rear fitting part engaging a lower, rear wall of the heat radiating part, said lower fitting part engaging a bottom wall of the heat radiating part, and said front fitting part engaging a lower, front wall of the heat radiating part.

8. The vehicular radiator unit according to claim 7, wherein said heat radiating part includes a lock pin projecting downwardly from the bottom wall of the heat radiating part, said lock pin extending through a gap formed in the lower fitting part of the holding arm.

9. The vehicular radiator unit according to claim 1, wherein said heat radiating part includes an upper tank, a lower tank and a core located therebetween, the arms other than the holding arm of said support stay being attached to an upper flange located on a side of the core and the body frame.

10. The vehicular radiator unit according to claim 1, further comprising a grille mounted to a front of the heat radiating part by a pair of support flanges, said grille covering the front of the heat radiating part.

11. A vehicular radiator unit comprising:
a radiator, said radiator including an upper tank, a lower tank and a core located therebetween;
a cooling fan, said cooling fan enhancing the heat radiation performance of the heat radiating part;
a support stay, said support stay supporting the cooling fan and being attached to the radiator and a body frame to support the radiator on the body frame, said support stay including a holding arm that holds the radiator by sandwiching a periphery thereof.

12. The vehicular radiator unit according to claim 11, wherein the periphery of the radiator is provided with a fastening part to which fastening arms of the support stay are fastened, each of the fastening arms being provided with fastened parts that are arranged in a plane parallel with a heat radiating surface of the radiator.

13. The vehicular radiator unit according to claim 12, further comprising a shroud that covers a portion of the periphery of the radiator that is provided with the fastening part, and the shroud is provided with a through part through which the fastening part and the fastened parts can project.

14. The vehicular radiator unit according to claim 11, wherein said holding arm includes a rear fitting part, a lower fitting part and a front fitting part, said rear fitting part engaging a rear wall of the lower tank of the radiator, said lower fitting part engaging a bottom wall of the lower tank of the radiator, and said front fitting part engaging a front wall of the lower tank of the radiator.

15. The vehicular radiator unit according to claim 14, wherein the lower tank of the radiator includes a lock pin projecting downwardly from the bottom wall thereof, said lock pin extending through a gap formed in the lower fitting part of the holding arm.

16. The vehicular radiator unit according to claim 11, wherein said support stay includes fastening arms that are attached to an upper flange located on a side of the core and the body frame.

17. The vehicular radiator unit according to claim 11, further comprising a grille mounted to a front of the radiator by a pair of support flanges, said grille covering the front of the radiator.
